(19) United States
(12) Patent Application Publication
(10) Pub. No.: US 2005/0091873 A1
(43) Pub. Date: May 5, 2005

(54) Fluidized bed process having a hydro dynamically active layer and a method for use thereof

(75) Inventor: Roman Maryakhin, Arad (IL)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: PARTICLE TREATMENT TECHNOLOGIES LTD., Arava (IL)

(21) Appl. No.: 11/003,646

(22) Filed: Dec. 6, 2004

Related U.S. Application Data
(63) Continuation of application No. PCT/IL03/00468, filed on Jun. 3, 2003.

(30) Foreign Application Priority Data
Jun. 5, 2002 (IL) 150052

(51) Int. Cl. F26B 3/08; A23G 3/00

(52) U.S. Cl. 34/360; 426/94

(57) ABSTRACT

The present invention relates to fluid bed processors used in various industries for drying, coating, agglomerating, and performing other specific processes on particle materials. The processor is especially useful for processing particles, utilizing a hydro dynamically active layer (HDAL) produced by introducing a high speed gas jet through said particulate material under controlled conditions. The processor is adapted to be implemented in a plurality of different fluid bed applications and results in much more efficient particle processing, and a significant savings in energy consumption. The present invention also relates to a method comprising the steps of introducing particulate material into the processing chamber and passing a high-speed jet gas through a plurality of nozzles located in the base of said processing chamber, thereby producing distinct regions of low pressure so as to create an intense, substantially circulatory pattern of gas circulation into which said particulate material is picked up.

### FIELD OF THE INVENTION

The present invention relates generally to the field of fluid bed processors used in various industries for drying, coating, agglomerating, and performing other specific processes on particle materials. More specifically, the present invention relates to a device especially useful for processing particles, utilizing a hydro dynamically active layer (HDAL) produced by introducing a high speed gas jet through said particulate material under controlled conditions. The device of the present invention may be implemented in a plurality of different fluid bed applications and results in much more efficient particle processing, and a significant savings in energy consumption. The present invention relates also to a method to processing the same.

### BACKGROUND OF THE INVENTION

Fluid bed technology is used in many different applications and industries for the purpose of processing particulate materials. Among the industries where fluid bed technology is regularly used or has the potential for being used is: foodstuffs and dairy products (additives, health food extracts, soup mixes, baby foods, carbohydrate processing, coffee, and dairy products), chemicals (fertilizers, inorganic salts, organic chemicals, pesticides, polymers, ceramics, detergents, paints), pharmaceuticals (proteins, vitamins, yeast, antibiotics, drugs).

A fluidized bed is a bed of solid particles with a stream of air or gas passing upward through the particles at a rate great enough to set them in motion. As the air travels through the bed, it imparts unique properties to the bed. The bed behaves like a liquid, so as to allow for processes such as agglomeration, coating, and drying, to be carried out efficiently. Depending on the type of application, different types of fluid beds can be produced. In conventional fluid bed systems, when the product is fluidized by a gas, the frictional force between the gas and the particles counterbalances the weight of the particles. A pressure drop is produced across the bed that is proportional to the weight of the bed. When the pressure drop is equal to the gravitational force acting on the particles, the bed is just fluidized and the gas velocity is at the fluidization velocity. The quantity of air required achieving minimum fluidization changes as the product's particle size or density changes.

Many types of fluid bed processors exist in the art, and each is directed towards a specific application or towards solving a specific problem inherent in fluid bed processing, of which there are many. Reference is thus made to U.S. Pat. No. 4,272,895 entitled “Product Reclamation in a Fluid Bed Dryer”, U.S. Pat. No. 6,189,234 entitled, “Continuous Flow Fluid Bed Dryer”, U.S. Pat. No. 4,492,040 entitled, “Method and Apparatus for Drying a Pulverulent or Particulate Product”, and U.S. Pat. No. 5,459,318 entitled, “Automated Fluid Bed Process,” among others.

Chief among the problems which these and other patented technologies have attempted to solve is the escape of particles from the fluid layer, the narrow gas velocity range required for achieving fluidization, and the low relative velocities between interacting phases. Especially in drying procedures, the energy and time needed to overcome the diffusion gradient in order to remove moisture remaining at the end of the process is extremely high, and while the first stage of the drying process may be considered energy-efficient, this stage is certainly not. Maintaining the wet material in the fluidized state during this final stage requires a large amount of heat energy, which is otherwise lost. Fluid bed dryers require a constant high flow rate in order to accomplish drying.

It is impossible to improve mass transfer by raising the relative velocities of the interacting phases, since increasing the gas velocity will result in the disappearance of the fluidized layer. Another problem occurs when processing particles that have a tendency to stick together. For example, amino acids containing 20-30% of water do not feature looseness. The material becomes loose and appropriate for fluidized bed processing only after reducing the humidity level by special means.

None of the currently available technologies satisfactorily solves all of the aforementioned problems: thus, it is almost impossible to intensify heat and mass transfer by increasing the relative velocities of interacting phases; high losses of material are underlined with the apparatus' wastes gas flow when processing polydispersed material; the available technologies usually required the utilization of special mechanical agitators in order to bring the material into a loose state suitable for fluidized bed processing; and lastly, the impossibility to reduce heat carrier consumption at the decreasing rate phase of the drying process, which results in the over-consumption of energy. The highly specific conditions required for carrying out various processes using fluidized beds, and the plethora of problems that arise which each advance in technology has provided the inventor of the present invention with the initiative to seek an entirely new approach to fluid bed processing.

### SUMMARY OF THE INVENTION

It is therefore one object of the present invention to present a fluid bed processor device, especially useful for processing particulate material, at a reactively high mass and heat exchange efficiency. Hence, according one embodiment said device comprising three components as follows: An inlet chamber, having an opening in which process gas is forced to intrude at a predetermined velocity. A nozzle grid, comprises a plurality of free passageways, each of which is having a predetermined groove cut from which said process gas stream is forced to extrude from the side of the inlet chamber to the side of a processing chamber. The velocity of said gas is in the range of 20 m/s to 350 m/s. Lastly the processing chamber which accommodating the particulate material to be processed. Said chamber is adapted to provide an outlet for said process gas intruding from the said nozzle grid, enabling both reduce pressure zones and zones of relatively higher pressure to be steadily formed. It is acknowledged that the aforementioned fluidized bed processor is characterized in that a hydro dynamically active layer (HDAL) is formed in said processing chamber, wherein said particulate material is having a constant circulatory movement stipulated by the circulatory of said process gas.

It is in the scope of the present inevntion wherein the above defined fluidized bed processor comprising the said HDAL, which provides intense circulatory motion caused by the gas flow in a relatively large range of velocities, so the overall ascending gas flow is below the hovering velocity of the said particulate material, without the escape of said particles from the HDAL and with the ability to treat highly polydisperse materials.

In particularly, it is in the scope of the present invention wherein the above defined fluid bed processor is adapted to process pastas and any other adhesive materials, characterized by a processing chamber having inert granules made of polymers or any other suitable organic compositions, inorganic materials or any mixture thereof. The average circumference diameter of said support granules is wider then the particles of said material to be processed. The mechanism of the granules action is so that whereas wet material is coating each of said granules so only dried and processed material is able to leave the processing chamber and whereas said granules are recycled so they are not leaving the processing chamber.

According to one particular embodiment of the present invention, said fluid bed processor is having a nozzle grid, comprises 40-3200 nozzles per square meter, and additionally or alternatively, each nozzle has a groove cut having diameter in the range of 0.7 to 7 mm at the side facing the said processing chamber. Moreover, it is specifically in the scope of the present invention wherein the gas jet outflow velocity at each nozzle is at least 100 m/s.

It is another object of the present invention to provide a material produced by the fluid bed processor as defined above. More specifically, the present invention relates to materials hereto defined, selected from foodstuffs, chemicals, pharmaceuticals or any particulate material to be dried, processed, reacted, coated, fractionated, separated or milled.

It is in the scope of the present invention to present the fluid bed processor as defined above, wherein particles to be processed are in heterogeneous mixture with inert particles in the processing chamber. Preferably, said inert particles are polymeric granules of 2 to 8 mm-external diameters. The actual diameter is determined according to the material to be processed and according to the velocity of the air jets, such that the air jets will be provide sufficient friction to lift the granules and force them to circulate, without let them left the chamber and flow out with the processed material. It should be taken into account however, that the ratio between surface area and between the mass of a granule decreases as the granule diameter increases, thus granules of smaller diameter increase the efficiency since they provide a greater surface area per a smaller self weight. They should be dimensioned however such that it will be possible to separate them from the processed material, either through an appropriate net, or by the flow of air leaving the chamber. Said processor is preferably comprising at least one net, having means to separate between inert particles and particles to be processed. The respectively humid particles to be processed are possible to be in heterogeneous mixture with inert particles. It is further acknowledged in this respect that the ratio between the external diameter of the humid particles to be processed and the external diameter of the inert particles is in the range of 1000:1 to 1:1000.

It is a last object of the present invention to provide a useful method for processing a particulate material by the fluidized bed processor as defined above; comprising introducing said particulate material into a processing chamber and passing a high-speed jet gas through a plurality of nozzles located in the base of said processing chamber, thereby producing distinct regions of low pressure so as to create an intense, substantially circulatory pattern of gas circulation into which said particulate material is picked up.

According to one embodiment of the present invention, the method is in particularly useful for processing a particulate material in a heterogeneous mixture by the fluidized bed processor. Said method is as defined above, additionally comprising at least one of the steps of (i) processing the said particulate material with inert material; (ii) passing the particulate material to be processed throughout a net, so the inert material is not passing said net; and/or (iii) purging the particulate material after it was processed throughout at least one outlet orifice.

In particularly, said method is especially useful according to the present invention to use in drying a particulate material, mixing at least two immiscible materials, in producing an aerosol, and in coating a particulate material, especially wherein the particulate material contains at least one amino acid.

### BRIEF DESCRIPTION OF THE INVENTION

In order to understand the invention and to see how it may be carried out in practice, a preferred embodiment will now be described, by way of non-limiting example only, with reference to the accompanying drawings, in which:

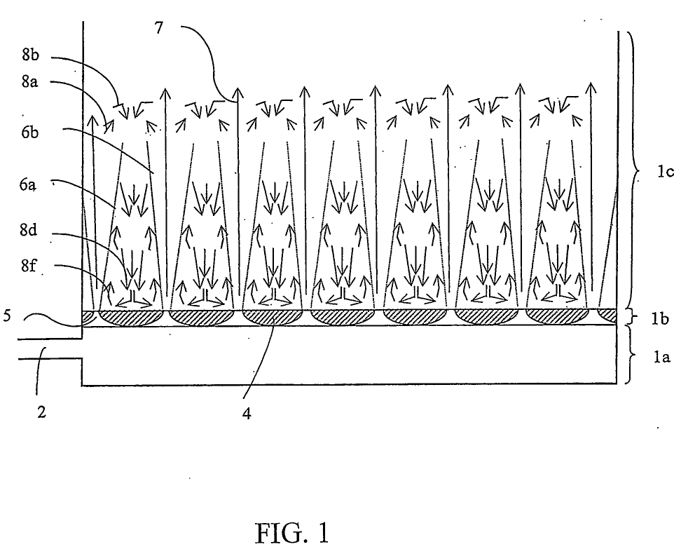

FIG. 1 presents zones of reduced pressure in a fluidized bed processor according to one preferred embodiment, wherein the circulate flow of the process gas enabled the formation of satiable HDAL defined in the present invention;

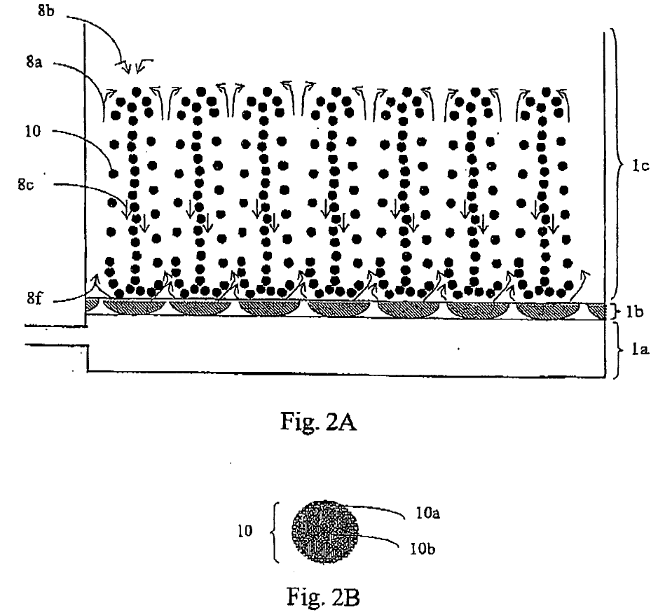

FIG. 2 presents a side view (cross section) of a fluidized bed processor according to another preferred embodiment of the present invention, especially adapted to process particulate material coated as a thin layer on a plurality of granules;

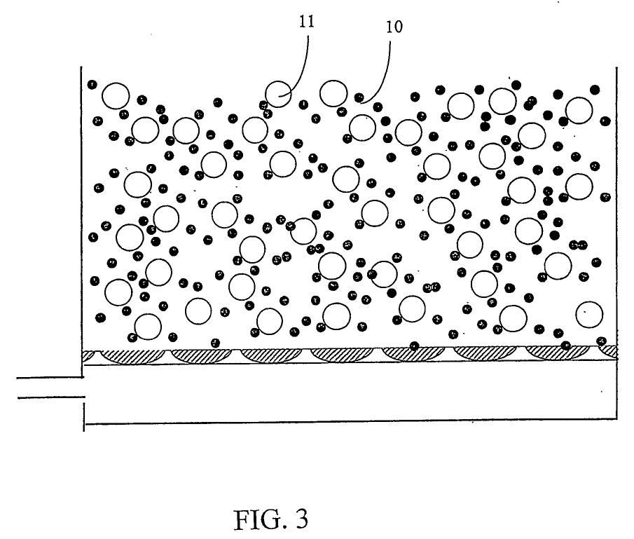

FIG. 3 presents a side view (cross section) of the HDAL comprising a heterogeneous mixture of particulate matter to be processed and inert material.

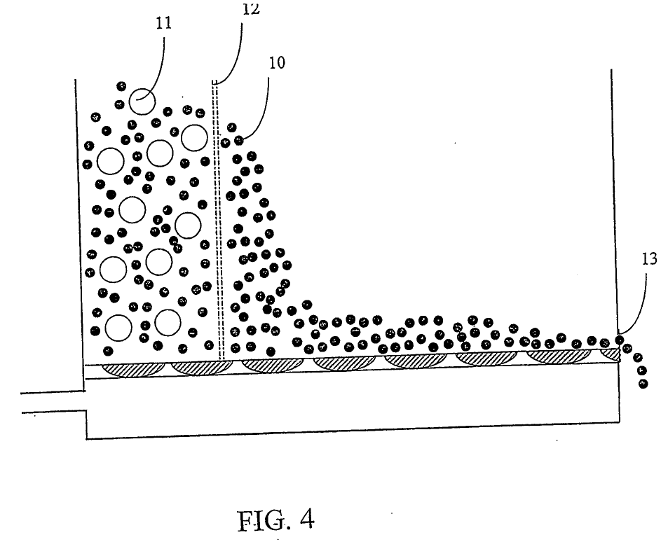

FIG. 4 presents a side view (cross section) of the HDAL as defined above, wherein the heterogeneous mixture is located in an initial working zone, well defined by means of a net.

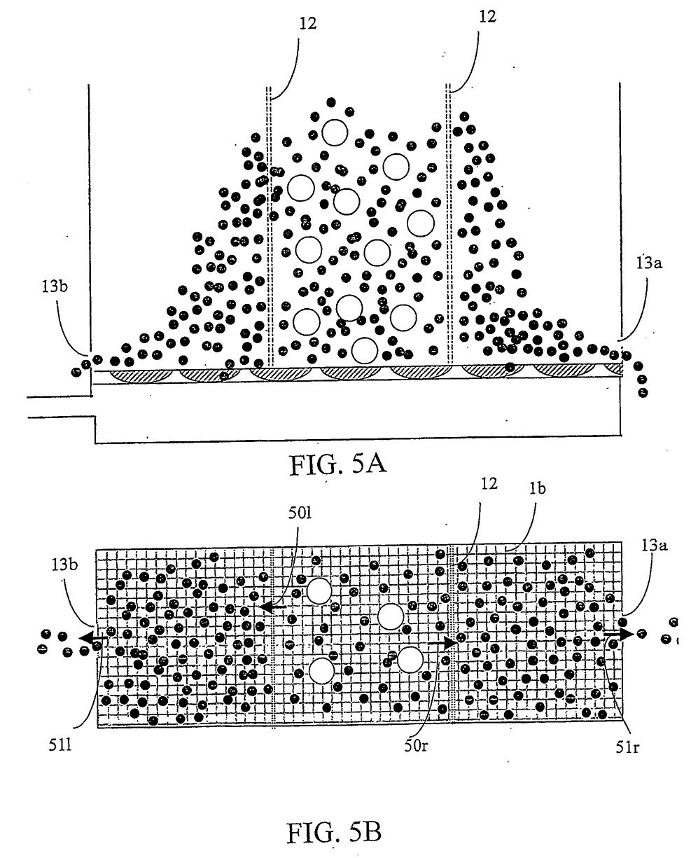

FIG. 5A presents a side view (cross section) of the HDAL as defined above; wherein the said HDAL has a circular initial working zone in the interior space of the HDAL.

FIG. 5B presents a top view of the same.

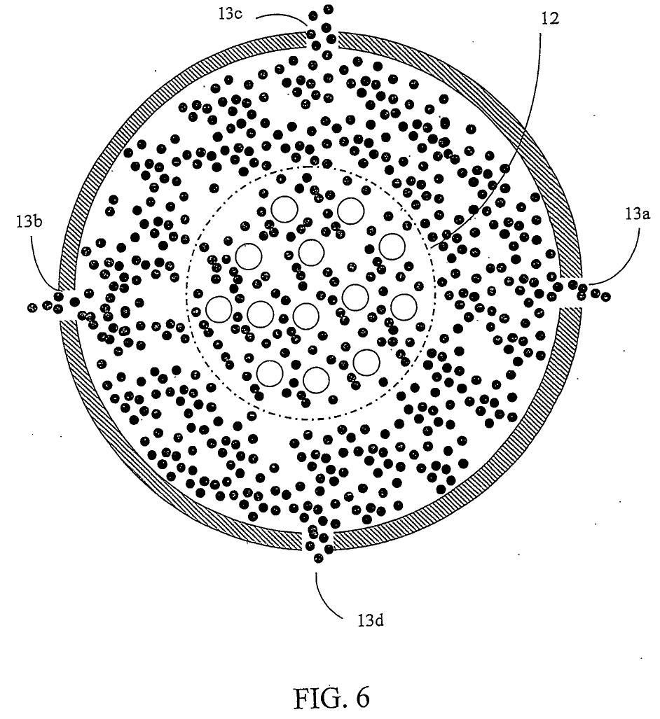

FIG. 6 presents a circular version of the apparatus in a top view with radial movement of the material to be dried; and

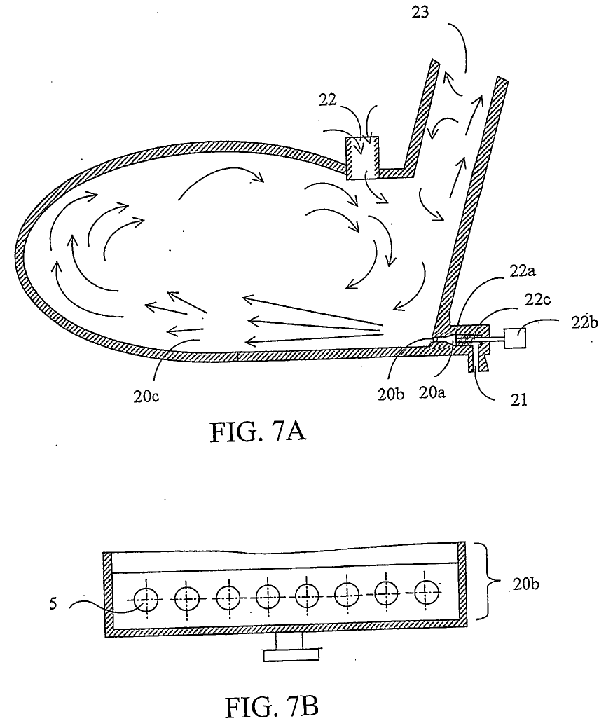

FIG. 7 presents a fluidized bed processor according to another preferred embodiment of the present invention, especially adapted to a continuous processing.

### DETAILED DESCRIPTION OF THE DRAWINGS

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically a fluidized bed processor useful for processing a particulate material.

Said device is based on the novel and non-obvious application of an otherwise well-known principle to traditional fluid bed processors. The modification of current fluid bed processors and the development of new ones using the method of the present invention provides for the formation of a hydro dynamically active layer, refereeing in the present invention in the term HDAL, produced when a high-speed gas jet is passed through a particulate material in the chamber of a fluid bed processor, in particular predetermined conditions hereto defined.

In said HDAL layer, particles are picked up by high-speed gas jets in order to form a highly intense, but controlled and organized flow through the process chamber of the device. The HDAL is entirely different in nature and behavior from those fluidized layers produced in current fluid bed processors, leads to more efficient processing, and reduced energy requirements, among other advantages.

It is well acknowledged in the present invention that HDAL represents a system resulting from the interaction of loose material having high speed discrete gas jets flowing from nozzels, under condition that speed of a total gas flow leaving the bed does not exceed the speed of fluidization of particles composing the layer. The gas jet outflow speed usually varies from 20 m/s to sonic and transonic speeds.

More specifically, the present invention relates to a device useful for processing a particulate material comprising introducing said particulate material into a processing chamber and passing a high-speed jet gas through a plurality of nozzles located in the base of said processing chamber, thereby producing distinct regions of low pressure so as to create an intense, substantially circulatory pattern of gas motion into which said particulate material is picked up, so as to become “fluidized” in a highly stable “hydro dynamically active layer”.

The HDAL phenomena results from the interaction between a plurality of high-speed gas jets interacting with a solid disperse phase of particulate material. Gas jet outflow can be described by the Bernoulli equation:
H=P/γ+V²/2g+hₗ (1)
wherein H is the overall hydraulic pressure head, P is the gas pressure, γ is the gas density, V is the gas velocity, g is the gravitational acceleration, hₗ is the loss of head, P/γ is the static head characterizing the potential energy of gas, V²/2g is the dynamic head characterizing the kinetic energy of the gas.

In the absence of loss, hₗ=0, and
H=P/γ+V²/2g (2)

Assuming that all potential energy at the outflow of the nozzles is transformed into kinetic energy,
V=(2gP/γ)^{1/2} (3)

Gas flow (Q) per unit time is:
Q=f*V (4)
wherein f is the cross sectional area of the orifice.

In actuality, the amount of discharged gas is less than that calculated from equation (4) because of gas compression at the orifice, and the real gas friction against the orifice.

The ration of the jet cross-section area ƒₛ to the orifice cross-section ƒ characterizing the degree of gas compression is called the jet compression coefficient ε:
ε=ƒₛ/ƒ (5)

The effect of the real gas friction forces is accounted for by the velocity coefficient φ:
φ=1/(1+ξ)^{1/2} (6)
wherein ξ is the resistance coefficient.

Taking into account jet compression and frictional forces, the gas flow rate at the outflow can be determined using the expression:
Q=φεƒ(2gP/γ)^{1/2}
or,
Q=μƒ(2gP/γ)^{1/2} (7)
wherein μ=εφ is the flow rate coefficient. In the majority of cases of air outflow from circular orifices, one may assume that μ=0.62/0.63.

Equation (7) can thus be represented as follows:
V=μ(2gP/γ)^{1/2} (8)

Equation (8) establishes the relationship between the outflow rate and the pressure.

According to the Bernoulli equation, in the regions of gas jet outflow, a plurality of reduced-pressure zones is created. Gas moves from the higher-pressure zones into intermediate zones (with reduced pressure). An intense, circulatory motion of gaseous flow is established, into which the particulate material is swept up. The high-speed and intense motion of the particles prevents them from aggregating with one another, a problem encountered often in conventional fluid beds. The intense movement of the particles raises heat and mass transfer coefficients.

The HDAL method may be employed using a processing chamber having a gas-distributing grid. The HDAL method is applicable for a wide range of linear and cross-sectional gas flow rates and solid phase polydispersity, and provides high homogeneity over all sections of the chamber. Preferably, the number of gas nozzles varies between comprises 40-3200 nozzles per square meter having diameters in the range of 0.7 to 7.0 mm in the side facing the processing chamber. It is appreciated that a larger diameter of the nozzles applies when a small number of nozzles per square meter is used, and vice versa. Normally, the open area (i.e. the total area of nozzle opening per a square meter of nozzle grid, in percents) will be less than 1%, and in most cases it will be only fractions of a percent.

Therefore, although the process in the processing chamber of the device of the present invention is very intensive and performed by high velocity air jets, e.g. of velocities of 20 meter/sec, 30 m/sec, and in many cases 60 meter/sec, 80, meter/sec, 100 meter/second and more, up to about 340 meter/sec, the air sufficiency of the device according to the present invention is low, due to the small open area. Accordingly, the device and the method according to the present invention allows for a significant reduction in energy consumption and allow for drying processes in relatively low temperatures of operation. Other appropriate nozzle number and nozzle sizes are possible as well.

Preferably, the gas jet outflow is at least 20 m/s up to 350 m/s. Alternatively, the gas jet outflow speed is at least 100 m/s. The respective gas pressure required to produce such flows varies between 0.02 to 0.7 Bars. The distinct pressure variations (and consequent velocity variations) produced inside the chamber causes an intense circulatory pattern of gas motion, and thus enabling the fluidized layer to be highly stable and to raise heat transfer coefficient of the particulate material.

The temperature of the gas at the nozzles is calculated with a consideration of the decrease in temperature that occurs at outflow from the nozzles (this can be between 1° C. to 4° C.).

Reference is made now to FIG. 1 presenting a lateral cross section of the fluid bed processor according to the present invention. The said device is preferably comprising three main compartments: an inlet chamber (1a); a barrier member (1b) and a processing chamber (1c). A feed stream of compressed gases is forced to intrude the inlet chamber via opening (2). The said gases enter then the barrier member (1b) made of the block member (4) which blocks the air passage between adjacent nozzles and allows for air passage from the inlet chamber to the processing chamber only through nozzles made in the barrier. The illustrated barrier member is a nozzle grid comprising a plurality of nozzles having a free passageway (see 5 for example), each of which has a predetermined groove cut shape.

The shape of the cut in the illustrated is for smoothing the air flow from the inlet chamber into the processing chamber. The groove cut may be a longitudinal one which crosses the nozzle grid through a plurality of nozzles arranged in a line. According to other embodiments the groove can be made individually per each nozzle as a radial cut having the illustrated cut shape (or any other acceptable radial shape having a diameter descending from bottom to top i.e. from the inlet chamber towards the processing chamber) in any vertical cross sections taken along the axis of an individual nozzle. Nevertheless, it is possible also to use plain crossing apertures as nozzles, in order to reduce manufacturing costs of the nozzle grid, since high velocity jets of air may be produced also through nozzles having unchanged diameter through the width of the block. In the illustrated embodiment however, the diameter of each nozzle at the inlet rim, is wider then the diameter at the rim adjacent to the processing chamber.

High-velocity gas jets (7) are extruded from each nozzle (5), producing reduced pressure zones at regions of the chamber immediately above the nozzles. Those zones are located between the line (6a) and (6b) in between two adjacent nozzles. Gas stream (such as 8a) flowing from the space between the reduced-pressure zones is having gradually upward course. Due to the above referred predetermined equilibrium between parameters of the upward course flow and parameters characterizing the said reduced-pressure zone, said stream (8a) is forced to alter its flow course and to enter said reduced pressure zone, see for example stream 8b, flowing with downward course.

Inside of each of reduced-pressure zone, two main streams are provided. In the inner core of said zone, a stream having gradually downward course (8d) is flowing towards the block member (4) of the barrier, whereat said stream is about to turbulent. Then, along the outer shell of said reduced-pressure zone, a stream having an upward course (8f) is flowing.

Reference is made now to one preferred embodiment as described in FIG. 2. FIG. 2 is thus presenting a lateral cross section of the fluid bed processor according to one embodiment the present invention. As described in FIG. 2B, the particle (10) presented in FIG. 2 is generally having two distinctive layers. The external layer is made of the particulate material to be processed (10a) and an inner layer, which is the granule (10b) to be reversibly coated by adhesive materials. At the time the said material is wet, its adhesive characteristic enable its attachment to the said granules so said granule is coated by said wet material. After respectively short time, due to enhanced mass and heat transfer coefficient of the described system, water is exit the coated material and thus the said material is loosing its adhesive characteristics, until it is finally exit the granule support and leave the processing chamber. Hence, said uncoated granules regenerated to be covered by fresh and wet material to be processed.

Said fluid bed processor comprising the aforementioned-coated granules is especially useful for processing adhesive materials, and particularly materials that are sticky when they are wet, and non-adhesive characteristics at the time the said material is respectively dried. Pastas or many other flavor materials are examples for such a material.

The particulate material is swept up into the gas flow (so as to become “fluidized”) along stream (8f), and travels at extremely high velocities downwards in a along the courses of streams (8a), (8b) and (8c). The chaotic collision of said particles, together with the hydrodynamic resistance of the medium, prevents escape of particles from the processing chamber (1c).

In conventional fluid beds, equilibrium is required between the lifting capacity of the ascending gas flow and the particle material weight in order to create a fluidized state. The gas velocity that allows for equilibrium is the hovering velocity of the particle. The hovering velocity is dependant on the mass, density, and shape of the particles being fluidized, as well as the density and viscosity of the gas. When the gas flow is below the hovering velocity, particles precipitate out of the fluidized layer and onto the bottom of the apparatus. In addition, if the hovering velocity is exceeded, particles escape from the processing chamber. Thus, the fluid bed is only stable within a certain critical range of velocities. The problem is aggravated by non-uniform particle sizes, densities, and shapes (this is the case with most in most particulate materials, which need treatment, in which the material is polydispersed).

Regarding the drawbacks of the sate of the art, the novel processor defined in the present invention is characterized with a HDAL having a high, constant flow rate of low pressure. The two flows streams (8f) and (8d) are having different relative pressures and relative velocities. Those streams of contrary courses create an intense, turbulent circulatory motion that causes the particulate material to be immediately picked up into the gas flow and to remain in the fluidized state inside the processing chamber (1c).

Thus, in the novel HDAL processor defined above, equilibrium between the weight of the particles and the ascending gas flow is not required because of the intense circulatory motion (and varying pressure regions) caused by the gas flow. The fluidized state can be achieved over a much larger range of velocities (in fact, the overall ascending gas flow is below the hovering velocity of the particulate material), without the escape of particles from the HDAL and with the ability to treat highly poly-disperse materials.

Very high relative interphase velocities are achieved using HDAL, thus sharply increasing heat and mass transfer coefficients. The HDAL can be adapted to result with a mechanical “tear-away” effect in which moisture on the surface of particles is removed due to the high relative speeds of the interacting phases. The tear-away effect, in contrast to diffusion moisture removal occurring in traditional fluid beds, makes the drying process much more energy efficient and less time-consuming. The removal of bonded water using traditional fluid beds required prolonged contact of the heat carrier with the disperse phase.

Moreover, HDAL is adapted to provide a much lower time and energy expenditure due to the tear-away effect. The tear-away effect also HDAL ideal for use in applications such as aerosol production, mixing of two or more immiscible fluids for producing highly-stable emulsions, crystallization of uniform powders from solutions, removing dusts from gases, trapping admixtures, etc.

Reference is made now to FIG. 3 presenting a lateral cross section of the fluid bed processor according to another embodiment of the present invention. In this type of HDAL, particle (10) to be processed is in heterogeneous mixture with particle (11). Particle (11) is a highly loose inert material with a grain size of significant difference, comparing processed particle (10). According to another embodiment of the present invention, which shall hereto described as an example to illustrate one possible characteristic; said inert particle (11) is a polymeric granule of 2 to 4 mm diameter. The inert particle (11) is placed into at least the initial portion of working zone of the HDAL. Humid materials to be treated are introduced into aforementioned portion of the working zone and evenly distributed to form a maximum area of a contact interface. Therefore, the material to be dried (10) is rapidly dehydrated, usually within a few seconds. The dehydration process may be performed in various ways, depending on the physco-chemical characteristics, the magnitude of initial hydration and the required final humidity of the material.

Reference is thus now made to FIG. 4, presenting schematically a cross section of another embodiment of the HDAL, comprising a distinctive section comprising a net, mesh, grill, lattice or any selective barrier, denoted hereafter in the term ‘net’ (12). The net (12) is dividing the working space into two compartments: an initial working zone (the portion located left to the net (12) and a final processing portion (right to the net 12). On the left, both inert particle (11) and material to be process (10) are to be treated. Respectively dried particles (10) are penetrating throughout the net (12) to be finally treated as a homogeneous mixture on the right compartment. Optionally, a purge outlet (13) is located at the right side of the said compartment, providing for a continuous process.

Reference is made now to FIG. 5A, presenting somewhat similar embodiment of the HDAL, wherein the initial working zone is now the central portion located inside the nets (12). Here again, both inert particle (11) and material to be process (10) are to be treated. Respectively dried particles (10) are penetrating throughout the net (12) to be finally treated. Optionally, a plurality of purge outlets (here presented outlets 13a and 13b) are located at the edge of the final processing compartment, providing for a continuous process.

Reference is made now to FIG. 5B, showing the top view of the HDAL as descried in FIG. 5A above. Said rectangle vessel comprises nets (12) wherein between both inert particle (11) and material to be process (10) are to be treated. Hot air is directed upwards both inert particle (11) and material to be process (10) is to be treated via a network of nozzles (1b). Respectively dry matter is escaping throughout the net in a right direction (50r) and left direction (50l). Dry matter is leaving the vessel via a plurality of outlets, such as left (51l) and right (51r) outlets.

FIG. 6 is schematically presenting a cross section of a rounded HDAL vessel from a top view. A gradually circular net (12) is located in a predetermined location along the circumference of the HDAL, wherein a few purge outlets (13a-d) are equally located in the apparatus rim.

It is acknowledged in this respect that HDAL as characterized in FIG. 6 was constructed. The initial working zone comprises some 61 nozzles, 2.0 mm diameter each, and the final processing portion comprises of 108 nozzles, 1.2 mm diameter each, wherein the total diameter of the nozzle grid comprising said nozzles is of about 180 mm. At least three materials were treated:

(i) Potassium nitrate having the formula KNO₃, of initial humidity of 4 to 5% was processed in said HDAL. The final humidity obtained was lower 0.1%.

(ii) SR-245 having the formula C₂₁H₆Br₉N₃O₃, of initial humidity of 15 to 17% was processed in said HDAL. The final humidity obtained was lower 0.5%.

(iii) Halobrom, Bromochloro-5,5-Dimethylhydantion and/or its commercial derivatives such as the one having the formula C₅H₆BrClN₂O₂, of initial humidity of 15 to 18% was processed in said HDAL. The final humidity obtained was lower 0.5%.

Those remarkable results emphasize the usefulness and effectively of the HDAL and the HDAL based process.

Reference is made now to FIG. 7A, presenting a lateral cross section to fluidized bed processor, especially adapted to a continuous operation. Said embodiment of the processor comprises of the inlet camber (20a), a nozzle grid (20b) and a processing chamber (20c). Process gas are intrude the said processor via opening 21, and passes the valve 22a which enables the user to regulate the inflow of said gas by means of an handle (22b) having axle and lever and spring (22c). The said inlet chamber is having, according one preferred embodiment of the present invention, a groove cut shape which substantially similar to the one presented above in the groove (5) of FIG. 1. FIG. 7B presents a cross section of magnified nozzle grid (20b), comprising a plurality of nozzles as such as (5).

The process gas is circularly flow along the curved inner walls of the said processing chamber, wherein fresh material to be processed is been introduced via opening (22), and wherein dry processed material is leaving the process chamber via opening (23). It is acknowledged that the above mentioned granules are suitable for use also in said continuous processor.

The fluidized bed processor according to the present invention is especially useful for processing particulate materials. Said material is selected, yet not limited to foodstuffs and dairy products, such as additives, health food extracts, soup mixes, baby foods, carbohydrate processing, coffee, and dairy products. In particularly, said processor is useful for pastas and other products made of flour and amino acid containing materials. The fluidized bed processor is also adapted to process chemicals, such as fertilizers, inorganic salts, organic chemicals, pesticides, polymers, ceramics, detergents, paints; and pharmaceuticals, selected for example from proteins, vitamins, yeast, antibiotics, and drugs.

The fluidized bed processor is adapted for various applications, selected, but not limited to drying, processing, reacting, coating, fractionating, separating or milling particulate materials defined above.

1. A fluid bed processor device especially useful for processing particulate material, at a reactively high mass and heat exchange efficiency comprising;
a. an inlet chamber, having an opening in which process gas is forced to intrude at a predetermined velocity;
b. a processing chamber accommodating the particulate material to be processed;
c. a nozzle grid located in the base of the processing chamber and forming a barrier between the inlet chamber and the processing chamber, and comprising a plurality of nozzles, each having a free passageway through which said process gas stream is forced to flow from the inlet chamber to the processing chamber as a jet having an outflow velocity into said process chamber in a velocity range of 20 m/s to 350 m/s, such that a steady circulatory motion of particulate material is swept by circulatory gaseous flow set up between zones of relatively higher pressure formed by said jets and reduced pressure zones formed between adjacent said jets, and such that a hydro dynamically active layer (HDAL) is formed in said processing chamber.

2. The fluidized bed processor according to claim 1, wherein the HDAL provides intense circulatory motion caused by the gas flow in a relatively large range of velocities, so the overall ascending gas flow is below the hovering velocity of the said particulate material, without the escape of said particles from the HDAL and with the ability to treat highly polydisperse materials.

3. The fluid bed processor according to claim 1, adapted to process pastas and any other adhesive materials, characterized by a processing chamber having inert granules of an average circumference diameter wider then the particles of said material to be processed, whereas wet material is coating each of said granules so only dried and processed material is able to leave the processing chamber and whereas said granules are recycled so they are not leaving the processing chamber.

4. The fluid bed processor according to claim 3, wherein said granules are organic compositions, inorganic materials or any mixture thereof.

5. The fluid bed processor according to claim 1, wherein the nozzle grid, comprises 40 to 3200 nozzles per square meter.

6. The fluid bed processor according to claim 5, wherein organic material is a polymer.

7. The fluid bed processor according to claim 1, wherein each nozzle has a groove cut having diameter in the range of 0.7 to 7.0 mm in the side facing the processing chambers.

8. The fluid bed processor according to claim 1, wherein the gas jet outflow velocity at each nozzle is varies from 20 m/s to sonic and transonic speeds.

9. The fluid bed processor according to claim 1, wherein particles to be processed is in heterogeneous mixture with inert particles in the processing chamber.

10. The fluid bed processor according to claim 9, wherein the inert particles are polymeric granules of 2 to 8 mm external diameter.

11. The fluid bed processor according to claim 1, comprising at least one net, having means to separate between inert particles and particles to be processed.

12. The fluid bed processor according to claim 11, wherein respectively humid particles to be processed are in heterogeneous mixture with inert particles.

13. The fluid bed processor according to claim 11, wherein the ratio between the external diameter of the humid particles to be processed and the external diameter of the inert particles is in the range of 1000:1 to 1:1000.

14. The fluid bed processor according to claim 11, additionally comprising at least one outlet orifice, adapted to allow processed material to efflux from the processor, so a continuous or semi-continuous process is obtained.

15. A material produced by the fluid bed processor as defined in claim 1.

16. The material according to claim 9, wherein said material is selected from lump-forming, paste-like foodstuffs, chemicals, pharmaceuticals, or any particulate material to be dried, processed, reacted, coated, fractionated, separated or milled.

17. The material according to claim 9, wherein said material is selected from emulsion, and/or aerosol comprising a mixture of at least two immiscible liquids and/or solids,

18. A method for processing a particulate material by the fluidized bed processor as defined in claim 1, comprising; introducing said particulate material into a processing chamber having a barrier member in its base comprising a plurality of nozzles and passing a high-speed jet gas through the plurality of nozzles located in the base of said processing chamber, thereby producing distinct regions of low pressure between each two adjacent nozzles so as to create a plurality of an intense, substantially circulatory patterns of gas circulation into which said particulate material is picked up.

19. The method according to claim 18, useful for processing a particulate material in a heterogeneous mixture by the fluidized bed processor, additionally comprising the step of processing the said particulate material with inert material.

20. The method according to claim 19, additionally comprising the step of passing the particulate material to be processed throughout a net, so the inert material is not passing said net.

21. The method according to claim 19, additionally comprising the step of purging the particulate material after it was processed throughout at least one outlet orifice.

22. A method according to claim 18, useful for use in drying a particulate material.

23. A method according to claim 18, useful for use in mixing at least two immiscible materials.

24. A method according to claim 18, useful for use in producing an aerosol.

25. A method according to claim 18, useful for coating a particulate material.

26. A method according to claim 18, wherein the particulate material contains at least one amino acid.

27. A fluid bed processor device according to claim 1, further comprising a plurality of granules in the processing chamber to be reversibly coated by pasta type or sticky material during its drying process.

28. A fluid bed processor device according to claim 1, further comprising at least one net or other selective barrier dividing the processing chamber into an initial working zone and a final processing zone, and further comprising in the initial working zone a plurality of granules to be reversibly coated by pasta type or sticky material during its drying process, wherein respectively dried material can pass the net or the selective barrier for a final treatment at the final processing zone.

29. A method for processing a particulate material according to claim 18, further comprising providing a plurality of granules in the processing chamber to be reversibly coated by paste type or sticky material during its drying process.

30. A method for processing a particulate material according to claim 18, further comprising providing a plurality of granules in an initial working zone of the processing chamber to be reversibly coated by pasta type or sticky material during its drying process, and further comprising final treatment of partially dried material in a final processing zone of the processing chamber divided from the initial processing zone by a net or other selective barrier.

31. The fluid bed processor according to claim 1, wherein each nozzle has a cut shape of descending diameter from the inlet chamber to the processing chamber.

32. The fluid bed processor according to claim 1, wherein each nozzle has an even cut shape from the inlet chamber to the processing chamber.
